(19) United States
(12) Patent Application Publication
(10) Pub. No.: US 2025/0070371 A1
(43) Pub. Date: Feb. 27, 2025

(54) PRISMATIC SECONDARY BATTERY

(71) Applicant: Prime Planet Energy & Solutions, Inc., Tokyo (JP)

(72) Inventor: Yasunori BABA, Kobe-shi (JP)

(21) Appl. No.: 18/761,314

(22) Filed: Jul. 2, 2024

(30) Foreign Application Priority Data
Aug. 23, 2023 (JP) 2023-135231

(51) Int. Cl. H01M 50/342; H01M 50/103; H01M 50/119; H01M 50/54; H01M 50/586

(52) U.S. Cl. CPC H01M 50/3425; H01M 50/103; H01M 50/119; H01M 50/54; H01M 50/586; H01M 2200/20

(57) ABSTRACT

In a prismatic secondary battery, a positive electrode terminal electrically connected to a positive electrode tab is provided on a third wall of a pair of third walls that faces the positive electrode tab, a negative electrode terminal electrically connected to a negative electrode tab is provided on a third wall of the pair of third walls that faces the negative electrode tab, at least one of the pair of second walls includes a base portion and a protruding portion protruding from the base portion in a direction away from a first end surface of the electrode assembly, and the protruding portion is provided with a gas-discharge valve that is fractured when pressure in a case becomes equal to or more than a predetermined value.

### CROSS REFERENCE TO RELATED APPLICATIONS

This nonprovisional application is based on Japanese Patent Application No. 2023-135231 filed on Aug. 23, 2023 with the Japan Patent Office, the entire contents of which are hereby incorporated by reference.

### BACKGROUND OF THE INVENTION

### Field of the Invention

The present technology relates to a prismatic secondary battery.

### Description of the Background Art

Each of Japanese Patent Laying-Open No. 2021-89812, Japanese Patent Laying-Open No. 2019-133854, and Japanese Patent Laying-Open No. 2022-149950 discloses a prismatic secondary battery provided with a gas-discharge valve that is fractured when pressure in a case becomes equal to or more than a predetermined value.

### SUMMARY OF THE INVENTION

From the viewpoint of reliability of the gas-discharge valve, there is still room for improvement in the prismatic secondary battery described in each of Japanese Patent Laying-Open No. 2021-89812, Japanese Patent Laying-Open No. 2019-133854, and Japanese Patent Laying-Open No. 2022-149950.

An object of the present technology is to provide a prismatic secondary battery including a gas-discharge valve having high reliability.

The present technology provides the following prismatic secondary battery.

[1] A prismatic secondary battery comprising: an electrode assembly including a positive electrode and a negative electrode; and a case that accommodates the electrode assembly, wherein the case includes a pair of first walls facing each other, a pair of second walls facing each other, and a pair of third walls facing each other, the electrode assembly has a positive electrode tab on a surface of the electrode assembly facing one of the pair of third walls, the positive electrode tab being electrically connected to the positive electrode, the electrode assembly has a negative electrode tab on a surface of the electrode assembly facing either of the pair of third walls, the negative electrode tab being electrically connected to the negative electrode, a positive electrode terminal electrically connected to the positive electrode tab is provided on the third wall of the pair of third walls that faces the positive electrode tab, a negative electrode terminal electrically connected to the negative electrode tab is provided on the third wall of the pair of third walls that faces the negative electrode tab, at least one of the pair of second walls includes a base portion and a protruding portion protruding from the base portion in a direction away from a first end surface of the electrode assembly, and the protruding portion is provided with a gas-discharge valve that is fractured when pressure in the case becomes equal to or more than a predetermined value.

[2] The prismatic secondary battery according to [1], wherein at least one of the pair of third walls is connected to a portion of the second wall at which the protruding portion is provided.

[3] The prismatic secondary battery according to [2], wherein the electrode assembly has a second end surface on which at least one of the positive electrode tab and the negative electrode tab is provided, a first space is formed between the protruding portion and the first end surface of the electrode assembly, a second space is formed between the third wall and the second end surface of the electrode assembly, and the first space and the second space communicate with each other.

[4] The prismatic secondary battery according to any one of [1] to [3], further comprising an insulating sheet disposed between the protruding portion and the first end surface of the electrode assembly, wherein the insulating sheet is disposed at a position close to the first end surface of the electrode assembly with respect to an inner surface of the protruding portion.

[5] The prismatic secondary battery according to any one of [1] to [4], wherein the protruding portion includes a first protruding portion included in one of the pair of second walls and a second protruding portion included in the other of the pair of second walls, and the gas-discharge valve includes a first gas-discharge valve provided in the first protruding portion and a second gas-discharge valve provided in the second protruding portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a secondary battery according to a first embodiment.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a diagram showing a state in which the secondary battery shown in FIG. 1 is viewed in a direction of arrow IV.

FIG. 5 is a front cross sectional view of the secondary battery shown in FIG. 1.

FIG. 6 is a front view showing a negative electrode raw plate before a negative electrode plate is formed.

FIG. 7 is a cross sectional view of the negative electrode raw plate shown in FIG. 6 along VII-VII.

FIG. 8 is a front view showing the negative electrode plate formed from the negative electrode raw plate.

FIG. 9 is a front view showing a positive electrode raw plate before a positive electrode plate is formed.

FIG. 10 is a cross sectional view of the positive electrode raw plate shown in FIG. 9 along X-X.

FIG. 11 is a front view showing the positive electrode plate formed from the positive electrode raw plate.

FIG. 12 is a diagram showing an electrode assembly and a current collector each removed from the secondary battery.

FIG. 13 is a front view of a connection structure between a negative electrode tab group and a negative electrode current collector.

FIG. 14 is a cross sectional view of the connection structure between the negative electrode tab group and the negative electrode current collector.

FIG. 15 is a perspective view showing the electrode assembly.

FIG. 16 is an enlarged view of the vicinity of an upper surface of a wound type electrode assembly.

FIG. 17 is an enlarged cross sectional view showing an exemplary shape of a protruding portion.

FIG. 18 is an enlarged cross sectional view showing a modification of the shape of the protruding portion.

FIG. 19 is a front cross sectional view of a secondary battery according to a second embodiment.

FIG. 20 is a diagram for illustrating a first space and a second space in the secondary battery according to the first embodiment.

FIG. 21 is a diagram for illustrating a first space and a second space in the secondary battery according to the second embodiment.

FIG. 22 is a perspective view showing a state in which secondary batteries according to the first embodiment are stacked to form a battery assembly.

FIG. 23 is a first diagram showing exemplary arrangements of the protruding portion and the gas-discharge valve.

FIG. 24 is a second diagram showing exemplary arrangements of the protruding portion and the gas-discharge valve.

FIG. 25 is a third diagram showing exemplary arrangements of the protruding portion and the gas-discharge valve.

FIG. 26 is a fourth diagram showing exemplary arrangements of the protruding portion and the gas-discharge valve.

FIG. 27 is a fifth diagram showing exemplary arrangements of the protruding portion and the gas-discharge valve.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “secondary battery” is not limited to a lithium ion battery, and may include other secondary batteries such as a nickel-metal hydride battery, a sodium ion battery, and a solid electrolyte secondary battery. In the present specification, the term “electrode” may collectively represents a positive electrode and a negative electrode.

It should be noted that in order to facilitate understanding of the invention, the size of each component in the figures may be illustrated to be changed from its actual size.

### First Embodiment

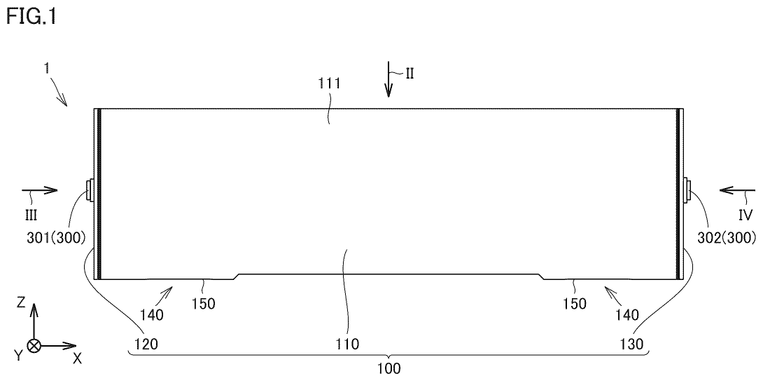

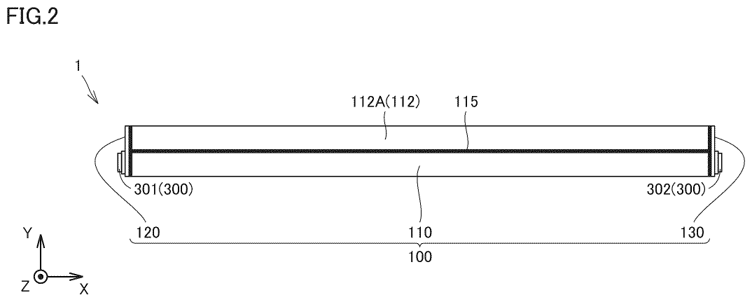

FIG. 1 is a front view of a secondary battery 1 according to a first embodiment. FIGS. 2 to 4 are diagrams showing states of secondary battery 1 shown in FIG. 1 when viewed in directions of arrows II, III, and IV respectively. FIG. 5 is a front cross sectional view of secondary battery 1 shown in FIG. 1.

Secondary battery 1 can be mounted on a battery electric vehicle (BEV), a plug-in hybrid electric vehicle (PHEV), a hybrid electric vehicle (HEV), or the like. It should be noted that the purpose of use of secondary battery 1 is not limited to the use on a vehicle.

It should be noted that in each of FIGS. 1 to 18 for the first embodiment, it is defined that: an X direction serving as a first direction represents a direction along a winding axis of an electrode assembly included in the secondary battery; a Y direction serving as a second direction represents a short-side direction of the electrode assembly when viewed in the first direction, the second direction being orthogonal to the first direction; and a Z direction serving as a third direction represents a long-side direction of the electrode assembly when viewed in the first direction, the third direction being orthogonal to the first direction.

Further, in the present embodiment, the first direction (X direction) may be referred to as a “width direction” of the secondary battery or the case main body, the second direction (Y direction) may be referred to as a “thickness direction” of the secondary battery or the case main body, and the third direction (Z direction) may be referred to as a “height direction” of the secondary battery or the case main body.

As shown in FIGS. 1 to 5, secondary battery 1 includes a case 100, an electrode assembly 200, electrode terminals 300, and current collectors 400. Case 100 includes a case main body 110, a first sealing plate 120, a second sealing plate 130, protruding portions 140, and gas-discharge valves 150.

Case main body 110 is constituted of a member having a tubular shape, more specifically, a prismatic tubular shape. Thus, secondary battery 1 having a prismatic shape is obtained. Case main body 110 is composed of a metal. Specifically, case main body 110 is composed of aluminum, an aluminum alloy, iron, an iron alloy, or the like.

As shown in FIGS. 1 and 2, first sealing plate 120 and second sealing plate 130 are provided at respective end portions of the case main body. Case main body 110 can be formed to have a prismatic tubular shape in, for example, the following manner: end sides of a plate-shaped member having been bent are brought into abutment with each other (joining portion 115 illustrated in FIG. 2) and are joined together (for example, laser welding). Each of the corners of the “prismatic tubular shape” may have a shape with a curvature. Joining portion 115 in the present embodiment extends on an outer peripheral surface portion of case main body 110 in the first direction (X direction).

In the present embodiment, case main body 110 is formed to be longer in the width direction (X direction) of secondary battery 1 than in each of the thickness direction (Y direction) and the height direction (Z direction) of secondary battery 1. The size (width) of case main body 110 in the X direction is preferably about 30 cm or more. In this way, secondary battery 1 can be formed to have a relatively large size (high capacity). The size (height) of case main body 110 in the Z direction is preferably about 20 cm or less, more preferably about 15 cm or less, and further preferably about 10 cm or less. Thus, (low-height) secondary battery 1 having a relatively low height can be formed, thus resulting in improved ease of mounting on a vehicle, for example.

Case main body 110 includes a pair of first side surface portions 111 (first walls) and a pair of second side surface portions 112 (second walls). The pair of first side surface portions 111 constitute parts of the side surfaces of case 100. The pair of second side surface portions 112 constitute an upper surface portion 112A and a bottom surface portion 112B of case 100. The pair of first side surface portions 111 and the pair of second side surface portions 112 are provided to intersect each other. The pair of first side surface portions 111 and the pair of second side surface portions 112 are connected at their respective end portions. Each of the pair of first side surface portions 111 has an area larger than that of each of the pair of second side surface portions 112.

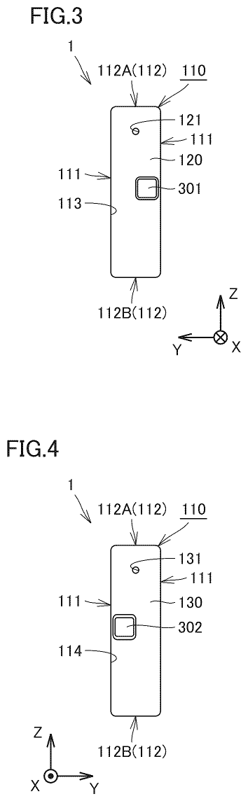

As shown in FIG. 3, a first opening 113 is provided at an end portion of case main body 110 on a first side in the first direction (X direction). First opening 113 is sealed by first sealing plate 120. Each of first opening 113 and first sealing plate 120 has a substantially rectangular shape in which the Y direction corresponds to its short-side direction and the Z direction corresponds to its long-side direction.

First sealing plate 120 is provided with a negative electrode terminal 301 (first electrode terminal) and an injection hole 121. The positions of negative electrode terminal 301 and injection hole 121 can be appropriately changed. First sealing plate 120 can be joined to case main body 110 by laser welding, for example.

As shown in FIG. 4, a second opening 114 is provided at an end portion of case main body 110 on a second side opposite to the first side in the first direction (X direction). Second opening 114 is sealed by second sealing plate 130. Each of second opening 114 and second sealing plate 130 has a substantially rectangular shape in which the Y direction corresponds to its short-side direction and the Z direction corresponds to its long-side direction.

Second sealing plate 130 is provided with a positive electrode terminal 302 (second electrode terminal) and an injection hole 131. The positions of positive electrode terminal 302 and injection hole 131 can be appropriately changed. Second sealing plate 130 can be joined to case main body 110 by laser welding, for example.

Each of first sealing plate 120 and second sealing plate 130 (third walls) is composed of a metal. Specifically, each of first sealing plate 120 and second sealing plate 130 is composed of aluminum, an aluminum alloy, iron, an iron alloy, or the like.

In one example, the thickness of each of first sealing plate 120 and second sealing plate 130 is thicker than the thickness (plate thickness) of case main body 110.

Negative electrode terminal 301 is electrically connected to a negative electrode of electrode assembly 200. Negative electrode terminal 301 is attached to first sealing plate 120, i.e., case 100.

Positive electrode terminal 302 is electrically connected to a positive electrode of electrode assembly 200. Positive electrode terminal 302 is attached to second sealing plate 130, i.e., case 100.

Negative electrode terminal 301 is composed of a conductive material (more specifically, a metal), and can be composed of copper, a copper alloy, or the like, for example. A portion or layer composed of aluminum or an aluminum alloy may be provided at a portion of an outer surface of negative electrode terminal 301.

Positive electrode terminal 302 is composed of a conductive material (more specifically, a metal), and can be composed of aluminum, an aluminum alloy, or the like, for example.

Each of injection holes 121, 131 is sealed with a sealing member (not shown). As the sealing member, for example, a blind rivet or another metal member can be used.

Electrode assembly 200 is an electrode assembly having a flat shape and having a below-described positive electrode plate and a below-described negative electrode plate. Specifically, electrode assembly 200 is a wound type electrode assembly in which a strip-shaped positive electrode plate and a strip-shaped negative electrode plate are both wound with a strip-shaped separator (not shown) being interposed therebetween. It should be noted that in the present specification, the “electrode assembly” is not limited to the wound type electrode assembly, and may be a stacked type electrode assembly in which a plurality of positive electrode plates and a plurality of negative electrode plates are alternately stacked. The strip-shaped separator can be constituted of, for example, a microporous membrane composed of polyolefin. The electrode assembly may include a plurality of positive electrode plates and a plurality of negative electrode plates, respective positive electrode tabs provided in the positive electrode plates may be stacked to form a positive electrode tab group, and respective negative electrode tabs provided in the negative electrode plates may be stacked to form a negative electrode tab group.

As shown in FIG. 5, case 100 accommodates electrode assembly 200. Electrode assembly 200 is accommodated in case 100 such that the winding axis thereof is parallel to the X direction.

Specifically, one or a plurality of the wound type electrode assemblies and an electrolyte solution (electrolyte) (not shown) are accommodated inside an insulating sheet disposed in case 100. The insulating sheet is disposed at a position close to a lower surface 271B (described later) of electrode assembly 200 with respect to an inner surface of protruding portion 140 of case 100. The “insulating sheet” herein is formed to be separated from the separator included in electrode assembly 200. The expression “facing” in the present technology also includes, for example, “facing with the insulating sheet being interposed”. It should be noted that the “insulating sheet” is not an essential configuration in the present technology.

As the electrolyte solution (non-aqueous electrolyte solution), it is possible to use, for example, a solution obtained by dissolving LiPF₆ at a concentration of 1.2 mol/L in a non-aqueous solvent obtained by mixing ethylene carbonate (EC), ethyl methyl carbonate (EMC), and diethyl carbonate (DEC) at a volume ratio (25° C.) of 30:30:40. It should be noted that instead of the electrolyte solution, a solid electrolyte may be used.

Electrode assembly 200 includes: a main body portion (portion in which a positive electrode plate and a negative electrode plate are stacked with a separator being interposed therebetween); a negative electrode tab group 220 (first electrode tab group); and a positive electrode tab group 250 (second electrode tab group). The main body portion of electrode assembly 200 corresponds to a rectangular portion other than negative electrode tab group 220 and positive electrode tab group 250.

The main body portion is constituted of a below-described negative electrode plate 210 and a below-described positive electrode plate 240. Negative electrode tab group 220 is located at an end portion of electrode assembly 200 on the first side with respect to the main body portion in the first direction (X direction). The first side in the present embodiment is the first sealing plate 120 side. Positive electrode tab group 250 is located at an end portion of electrode assembly 200 on the second side with respect to the main body portion in the first direction (X direction). The second side in the present embodiment is the second sealing plate 130 side.

Each of negative electrode tab group 220 and positive electrode tab group 250 is formed to protrude from a central portion of electrode assembly 200 toward first sealing plate 120 or second sealing plate 130.

Current collectors 400 include a negative electrode current collector 410 (first current collector) and a positive electrode current collector 420 (second current collector). Each of negative electrode current collector 410 and positive electrode current collector 420 is constituted of a plate-shaped member. Electrode assembly 200 is electrically connected to negative electrode terminal 301 and positive electrode terminal 302 through current collectors 400.

Negative electrode current collector 410 is disposed on first sealing plate 120 with an insulating member composed of a resin being interposed therebetween. Negative electrode current collector 410 is electrically connected to negative electrode tab group 220 and negative electrode terminal 301. Negative electrode current collector 410 is composed of a conductive material (more specifically, a metal), and can be composed of copper, a copper alloy, or the like, for example.

Positive electrode current collector 420 is disposed on second sealing plate 130 with an insulating member composed of a resin being interposed therebetween. Positive electrode current collector 420 is electrically connected to positive electrode tab group 250 and positive electrode terminal 302. Positive electrode current collector 420 is composed of a conductive material (more specifically, a metal), and can be composed of aluminum, an aluminum alloy, or the like, for example. It should be noted that positive electrode tab group 250 may be electrically connected to second sealing plate 130 directly or via positive electrode current collector 420. In this case, second sealing plate 130 may serve as positive electrode terminal 302.

Bottom surface portion 112B of case main body 110 has a base portion 112B0 formed at a central portion thereof along electrode assembly 200 in the X direction, and protruding portions 140 each protruding in a direction away from electrode assembly 200 are formed on both sides beside base portion base portion 112B0 (both end portions in the X direction).

A shortest distance (clearance) between an inner surface of base portion 112B0 and a lower surface 271B (described later) of electrode assembly 200 in the Z direction is, for example, preferably 5 mm or less, more preferably 3 mm or less, and further preferably 1 mm or less.

A protruding height of each protruding portion 140 (distance between the inner surface of base portion 112B0 and the inner surface of protruding portion 140 in the Z direction) is preferably, for example, about 1 mm or more, and more preferably about 3 mm or more.

Protruding portion 140 is provided with gas-discharge valve 150. Gas-discharge valve 150 is formed in bottom surface portion 112B separated from the winding axis of wound type electrode assembly 200. Gas-discharge valve 150 is fractured when pressure in case 100 becomes equal to or more than a predetermined value. Gas-discharge valve 150 can be formed by providing a thin portion or groove portion in protruding portion 140.

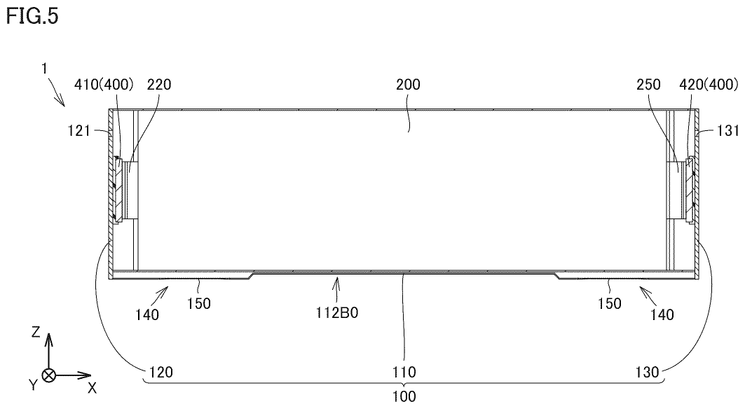

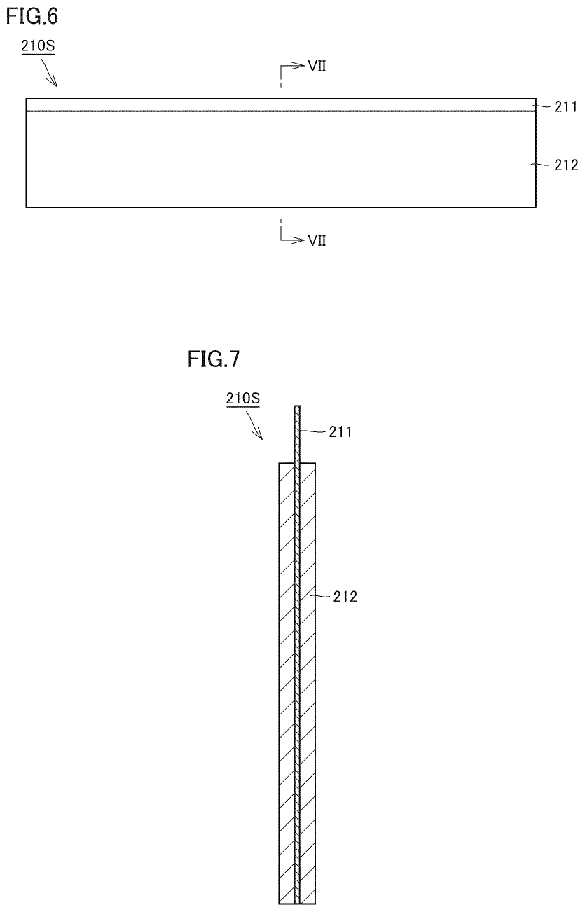

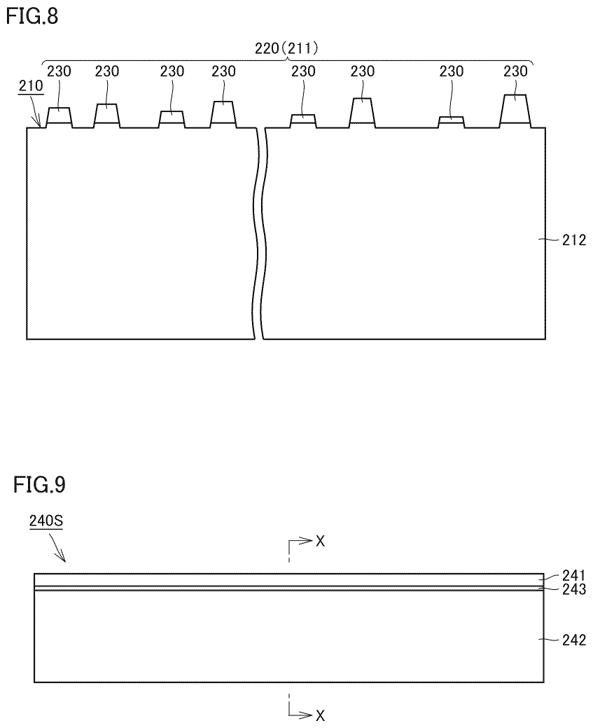

FIG. 6 is a front view showing a negative electrode raw plate 210S before negative electrode plate 210 (first electrode) is formed, FIG. 7 is a cross sectional view of negative electrode raw plate 210S shown in FIG. 6 along VII-VII, and FIG. 8 is a front view showing negative electrode plate 210 formed from negative electrode raw plate 210S.

Negative electrode plate 210 is manufactured by processing negative electrode raw plate 210S. As shown in FIGS. 6 and 7, negative electrode raw plate 210S includes a negative electrode core body 211 and a negative electrode active material layer 212. Negative electrode core body 211 is a copper foil or a copper alloy foil.

Negative electrode active material layer 212 is formed on negative electrode core body 211 except for each of end portions of both surfaces of negative electrode core body 211 on one side. Negative electrode active material layer 212 is formed by applying a negative electrode active material layer slurry using a die coater.

The negative electrode active material layer slurry is produced by kneading graphite serving as a negative electrode active material, styrene-butadiene rubber (SBR) and carboxymethyl cellulose (CMC) each serving as a binder, and water serving as a dispersion medium such that the mass ratio of the graphite, the SBR, and the CMC is about 98:1:1.

Negative electrode core body 211 having the negative electrode active material layer slurry applied thereon is dried to remove the water included in the negative electrode active material layer slurry, thereby forming negative electrode active material layer 212. Further, by compressing negative electrode active material layer 212, negative electrode raw plate 210S including negative electrode core body 211 and negative electrode active material layer 212 is formed. Negative electrode raw plate 210S is cut into a predetermined shape, thereby forming negative electrode plate 210. Negative electrode raw plate 210S can be cut by laser processing with application of an energy ray, die processing, cutter processing, or the like.

As shown in FIG. 8, a plurality of negative electrode tabs 230 each constituted of negative electrode core body 211 are provided at one end portion, in the width direction, of negative electrode plate 210 formed from negative electrode raw plate 210S. When negative electrode plate 210 is wound, the plurality of negative electrode tabs 230 are stacked to form negative electrode tab group 220. Thus, negative electrode tab group 220 is connected to negative electrode plate 210 (first electrode). The position of each of the plurality of negative electrode tabs 230 and the length thereof in the protruding direction are appropriately adjusted in consideration of the state in which negative electrode tab group 220 is connected to negative electrode current collector 410. It should be noted that the shape of negative electrode tab 230 is not limited to the one illustrated in FIG. 8.

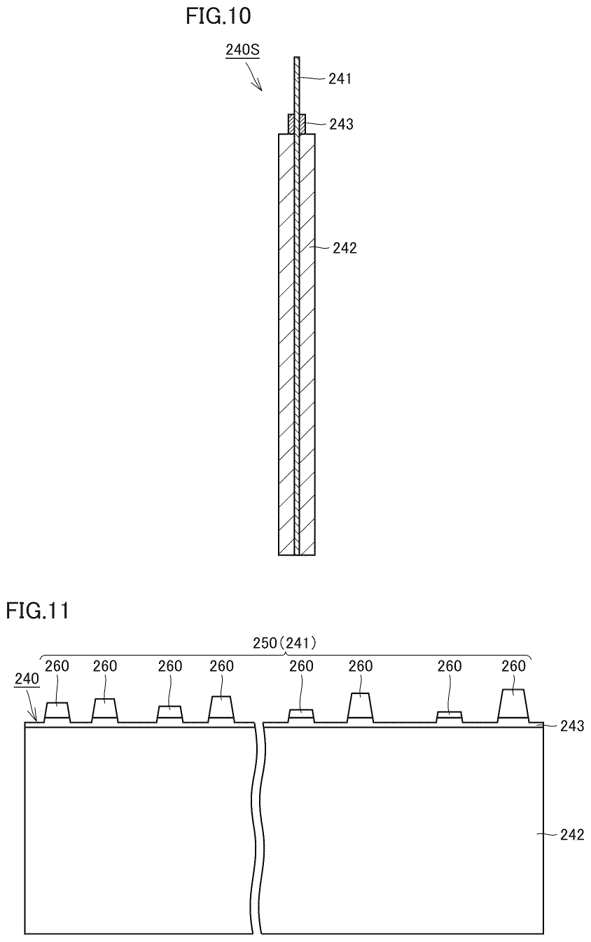

FIG. 9 is a front view showing a positive electrode raw plate 240S before positive electrode plate 240 (second electrode) is formed, FIG. 10 is a cross sectional view of positive electrode raw plate 240S shown in FIG. 9 along X-X, and FIG. 11 is a front view showing positive electrode plate 240 formed from positive electrode raw plate 240S.

Positive electrode plate 240 serving as the second electrode has a polarity different from a polarity of negative electrode plate 210 serving as the first electrode. Positive electrode plate 240 is manufactured by processing positive electrode raw plate 240S. As shown in FIGS. 9 and 10, positive electrode raw plate 240S includes a positive electrode core body 241, a positive electrode active material layer 242, and a positive electrode protective layer 243. Positive electrode core body 241 is an aluminum foil or an aluminum alloy foil.

Positive electrode active material layer 242 is formed on positive electrode core body 241 except for each of end portions of both surfaces of positive electrode core body 241 on one side. Positive electrode active material layer 242 is formed on positive electrode core body 241 by applying a positive electrode active material layer slurry using a die coater.

The positive electrode active material layer slurry is produced by kneading a lithium-nickel-cobalt-manganese composite oxide serving as a positive electrode active material, polyvinylidene difluoride (PVdF) serving as a binder, a carbon material serving as a conductive material, and N-methyl-2-pyrrolidone (NMP) serving as a dispersion medium such that the mass ratio of the lithium-nickel-cobalt-manganese composite oxide, the PVdF, and the carbon material is about 97.5:1:1.5.

Positive electrode protective layer 243 is formed in contact with positive electrode core body 241 at an end portion of positive electrode active material layer 242 on the one side in the width direction. Positive electrode protective layer 243 is formed on positive electrode core body 241 by applying a positive electrode protective layer slurry using a die coater. Positive electrode protective layer 243 has an electrical resistance larger than that of positive electrode active material layer 242.

The positive electrode protective layer slurry is produced by kneading alumina powder, a carbon material serving as a conductive material, PVdF serving as a binder, and NMP serving as a dispersion medium such that the mass ratio of the alumina powder, the carbon material, and the PVdF is about 83:3:14.

Positive electrode core body 241 having the positive electrode active material layer slurry and the positive electrode protective layer slurry applied thereon is dried to remove the NMP included in the positive electrode active material layer slurry and the positive electrode protective layer slurry, thereby forming positive electrode active material layer 242 and positive electrode protective layer 243. Further, by compressing positive electrode active material layer 242, positive electrode raw plate 240S including positive electrode core body 241, positive electrode active material layer 242, and positive electrode protective layer 243 is formed. Positive electrode raw plate 240S is cut into a predetermined shape, thereby forming positive electrode plate 240. Positive electrode raw plate 240S can be cut by laser processing with application of an energy ray, die processing, cutter processing, or the like.

As shown in FIG. 11, a plurality of positive electrode tabs 260 each constituted of positive electrode core body 241 are provided at one end portion, in the width direction, of positive electrode plate 240 formed from positive electrode raw plate 240S. When positive electrode plate 240 is wound, the plurality of positive electrode tabs 260 are stacked to form positive electrode tab group 250. Thus, positive electrode tab group 250 is connected to positive electrode plate 240 (second electrode). The position of each of the plurality of positive electrode tabs 260 and the length thereof in the protruding direction are appropriately adjusted in consideration of the state in which positive electrode tab group 250 is connected to positive electrode current collector 420. It should be noted that the shape of positive electrode tab 260 is not limited to the one illustrated in FIG. 11.

Positive electrode protective layer 243 is provided at the root of each of the plurality of positive electrode tabs 260. Positive electrode protective layer 243 may not necessarily be provided at the root of positive electrode tab 260.

In a typical example, the thickness of (one) negative electrode tab 230 is smaller than the thickness of (one) positive electrode tab 260. In this case, the thickness of negative electrode tab group 220 is smaller than the thickness of positive electrode tab group 250.

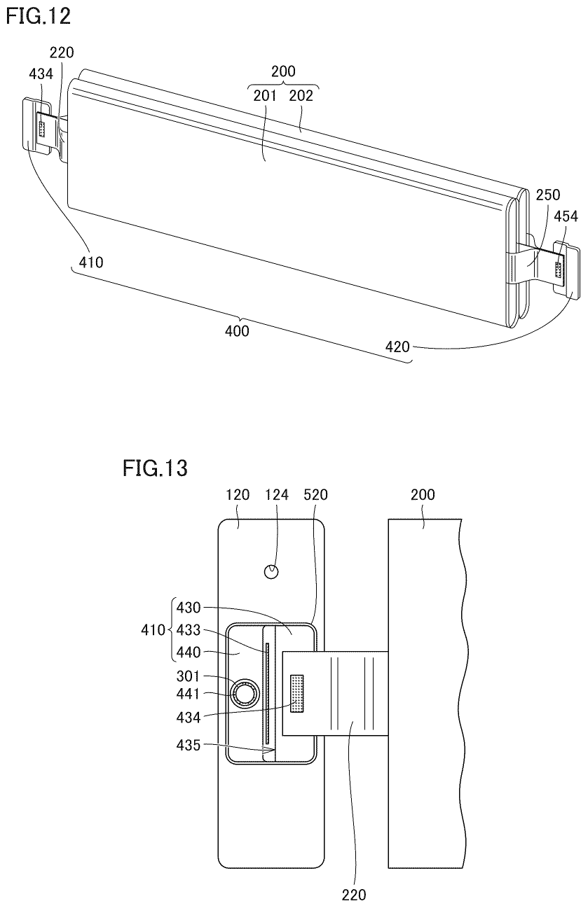

FIG. 12 is a diagram showing electrode assembly 200 and current collector 400 each removed from secondary battery 1. As shown in FIG. 12, electrode assembly 200 is formed by stacking two electrode assemblies 201, 202, each of which is a wound type electrode assembly. Although FIG. 12 illustratively shows the structure in which two wound type electrode assemblies are stacked, electrode assembly 200 may be constituted of one wound type electrode assembly, may be constituted of three or more wound type electrode assemblies, or may be constituted of a stacked type electrode assembly.

Negative electrode tab group 220 is joined to negative electrode current collector 410 at a joining location 434 and positive electrode tab group 250 is joined to positive electrode current collector 420 at a joining location 454.

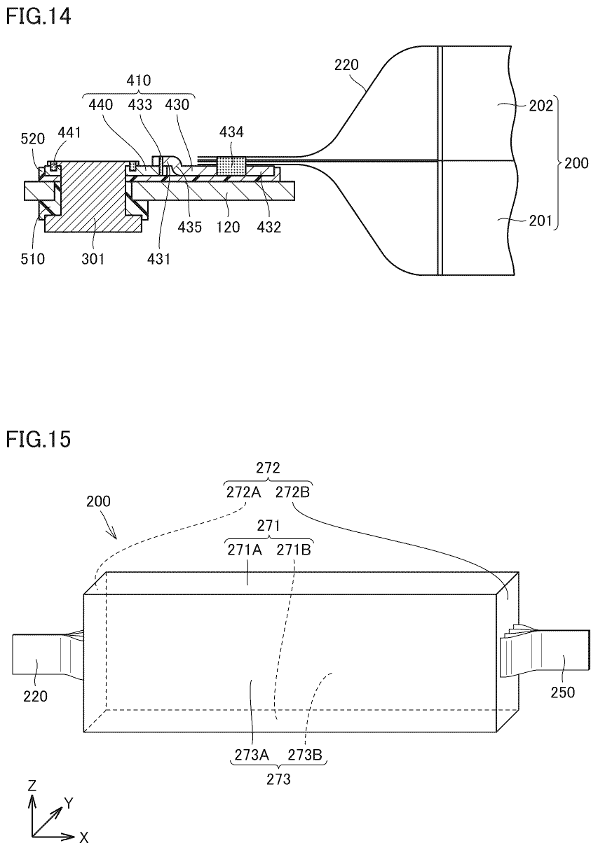

FIG. 13 is a front view of a connection structure between the negative electrode tab group and the negative electrode current collector. FIG. 14 is a cross sectional view of the connection structure between the negative electrode tab group and the negative electrode current collector.

As shown in FIGS. 13 and 14, negative electrode current collector 410 electrically connects negative electrode terminal 301 and negative electrode tab group 220. Negative electrode current collector 410 in the present embodiment is connected to negative electrode terminal 301 between electrode assembly 200 and first sealing plate 120.

Negative electrode current collector 410 includes a first conductive member 430 and a second conductive member 440. First conductive member 430 and second conductive member 440 are joined to each other at a joining location 433. First conductive member 430 and second conductive member 440 are joined by, for example, laser welding.

First conductive member 430 is joined to negative electrode tab group 220 at a joining location 434. Joining location 434 can be formed by, for example, ultrasonic welding, resistance welding, laser welding, swaging, or the like. In the present embodiment, first conductive member 430 and negative electrode tab group 220 are joined by, for example, ultrasonic bonding.

Second conductive member 440 is connected to negative electrode terminal 301 at a joining location 441. Joining location 441 can be formed by, for example, ultrasonic welding, resistance welding, laser welding, swaging, or the like. In the present embodiment, negative electrode terminal 301 and second conductive member 440 are joined by, for example, providing a through hole in second conductive member 440, inserting negative electrode terminal 301 into the through hole, swaging negative electrode terminal 301 on second conductive member 440, and then welding the swaged portion and second conductive member 440.

First conductive member 430 has a first flat surface portion 431 and a second flat surface portion 432. First flat surface portion 431 is connected to second conductive member 440. Second flat surface portion 432 is connected to negative electrode tab group 220. Second flat surface portion 432 is disposed along first sealing plate 120.

A stepped portion 435 is provided between first flat surface portion 431 and second flat surface portion 432. In a state after secondary battery 1 is assembled, the positions of first flat surface portion 431 and second flat surface portion 432 in the first direction (X direction) are made different by stepped portion 435. Thus, first flat surface portion 431 and second flat surface portion 432 can be arranged side by side in one direction. Stepped portion 435 extends along the third direction (Z direction).

A first insulating member 510 (resin member) is disposed between negative electrode terminal 301 and first sealing plate 120. A second insulating member 520 (resin member) is disposed between first sealing plate 120 and each of first conductive member 430 and second conductive member 440. It should be noted that first insulating member 510 and second insulating member 520 may be an integrated component.

Negative electrode terminal 301 is attached to first sealing plate 120 with first insulating member 510 being interposed therebetween. Negative electrode terminal 301 is provided to be exposed to the outside of first sealing plate 120 and reach second conductive member 440 of negative electrode current collector 410 provided on the inner surface side of first sealing plate 120.

As a procedure for assembling each component, first, negative electrode terminal 301 and second conductive member 440 as well as first insulating member 510 and second insulating member 520 are attached to first sealing plate 120. Next, first conductive member 430 electrically connected to electrode assembly 200 is attached to second conductive member 440. On this occasion, first conductive member 430 is disposed on first insulating member 510 such that a portion of first conductive member 430 overlaps with second conductive member 440. Next, first conductive member 430 and second conductive member 440 are welded and connected to each other at joining location 434.

It should be noted that negative electrode terminal 301 may be electrically connected to first sealing plate 120. Further, first sealing plate 120 may serve as negative electrode terminal 301.

It should be noted that each of FIGS. 13 and 14 illustrates negative electrode current collector 410 constituted of two components (first conductive member 430 and second conductive member 440); however, negative electrode current collector 410 may be constituted of one component.

Each of FIGS. 13 and 14 shows the connection structure on the negative electrode side; however, the basic connection structure on the positive electrode side is the same as that on the negative electrode side.

FIG. 15 is a perspective view showing electrode assembly 200. As shown in FIG. 15, the main body portion of electrode assembly 200 has an upper surface 271A and a lower surface 271B (first end surfaces), short side surfaces 272A, 272B (second end surfaces), and long side surfaces 273A, 273B (third end surfaces). Upper surface 271A and lower surface 271B face first side surface portions 111 of case main body 110, respectively. Short side surfaces 272A, 272B face first sealing plate 120 and second sealing plate 130, respectively. Long side surfaces 273A, 273B face second side surface portions 112 of case main body 110, respectively.

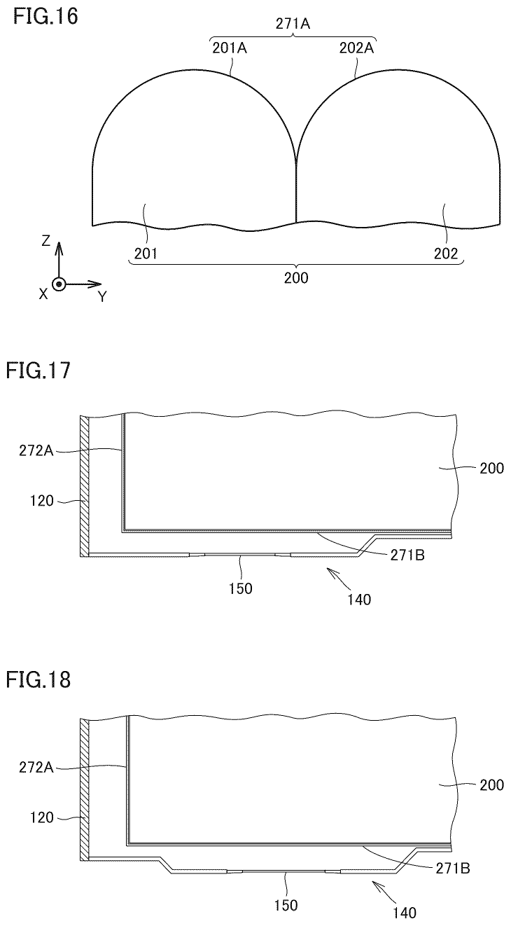

FIG. 16 is an enlarged view of the vicinity of upper surface 271A of electrode assembly 200. As shown in FIG. 16, when wound type electrode assemblies 201, 202 are stacked to form electrode assembly 200, upper surface 271A of electrode assembly 200 is formed to conform to respective curved surfaces 201A, 202A of electrode assemblies 201, 202.

According to the shape of upper surface 271A shown in FIG. 16, an empty space located between curved surfaces 201A, 202A can be used as a path for gas in case 100.

It should be noted that the shape of lower surface 271B is not shown but can be the same as that of upper surface 271A shown in FIG. 16.

FIG. 17 is an enlarged cross sectional view showing the shape of protruding portion 140. FIG. 18 is an enlarged cross sectional view showing a modification of the shape of protruding portion 140.

In the example shown in FIG. 17, first sealing plate 120 (third wall) and a portion of bottom surface portion 112B (second wall) of case main body 110 at which protruding portion 140 is provided are connected to each other. In the example shown in FIG. 18, first sealing plate 120 (third wall) and the portion of bottom surface portion 112B (second wall) of case main body 110 at which protruding portion 140 is provided are separated from each other in the X direction.

In each of the examples of FIGS. 17 and 18, a space (first space) formed between protruding portion 140 and lower surface 271B (first end surface) of electrode assembly 200 communicates with a space (second space) formed between first sealing plate 120 and short side surface 272A (second end surface) of electrode assembly 200.

In this way, a discharge path to gas-discharge valve 150 can be stably secured in case 100. Specifically, the gas discharged from short side surface 272A of wound type electrode assembly 200 to the outside of electrode assembly 200 can be guided to the space formed on the inner side with respect to protruding portion 140 and can be discharged to the outside of case 100 through gas-discharge valve 150 formed in protruding portion 140. It should be noted that in the present technology, the two spaces (the first space and the second space) do not necessarily need to directly communicate with each other.

### Second Embodiment

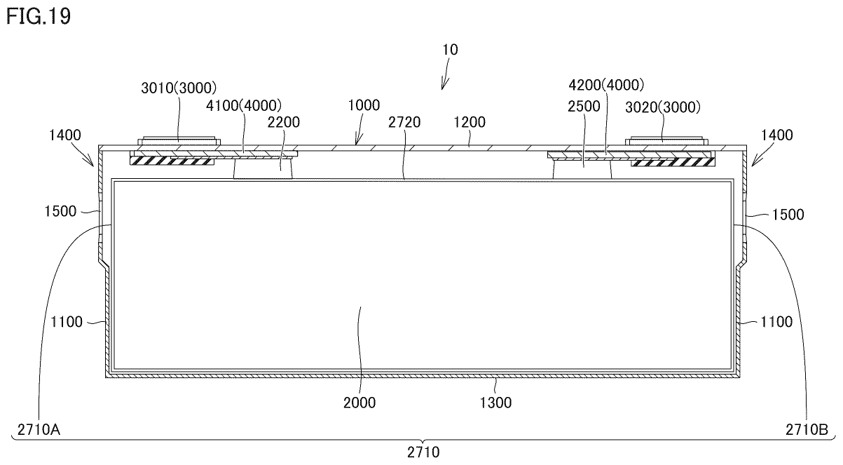

FIG. 19 is a front cross sectional view of a secondary battery 10 according to a second embodiment. As shown in FIG. 19, secondary battery 10 includes a case 1000, an electrode assembly 2000, electrode terminals 3000, and current collectors 4000.

Case 1000 includes: a case main body having a bottom and including side surface portions 1100 and a bottom surface portion 1300; a sealing plate 1200; protruding portions 1400; and gas-discharge valves 1500.

Electrode assembly 2000 has a pair of side surfaces 2710 (first end surfaces) and an upper surface 2720 (second end surface). Upper surface 2720 is provided with a negative electrode tab group 2200 and a positive electrode tab group 2500. Electrode assembly 2000 is a wound type electrode assembly in which a positive electrode plate and a negative electrode plate are wound around a winding axis extending in the upward/downward direction in FIG. 19. It should be noted that electrode assembly 2000 may be a stacked type electrode assembly.

Negative electrode tab group 2200 is electrically connected to a negative electrode terminal 3010 through a negative electrode current collector 4100. Positive electrode tab group 2500 is electrically connected to a positive electrode terminal 3020 through a positive electrode current collector 4200.

Side surfaces 2710 of electrode assembly 2000 include side surfaces 2710A, 2710B respectively formed on the left and right sides in the figure. Protruding portions 1400 include: a left protruding portion 1400 (first protruding portion) provided at a position facing side surface 2710A of electrode assembly 2000; and a right protruding portion 1400 (second protruding portion) provided at a position facing side surface 2710B of electrode assembly 2000. Gas-discharge valves 1500 include: a left gas-discharge valve 1500 (first gas-discharge valve) provided in left protruding portion 1400; and a right gas-discharge valve 1500 (second gas-discharge valve) provided in right protruding portion 1400. That is, in the present embodiment, each of the pair of gas-discharge valves 1500 is formed in side surface portion 1100 separated from the winding axis of wound type electrode assembly 2000.

It should be noted that protruding portions 1400 and gas-discharge valves 1500 are not limited to being formed on the left and right sides, and protruding portion 1400 and gas-discharge valve 1500 may be provided only in surface portion 1100 on one side.

The other matters are the same as those of the first embodiment, and therefore will not be described in detail repeatedly.

### (First Space and Second Space)

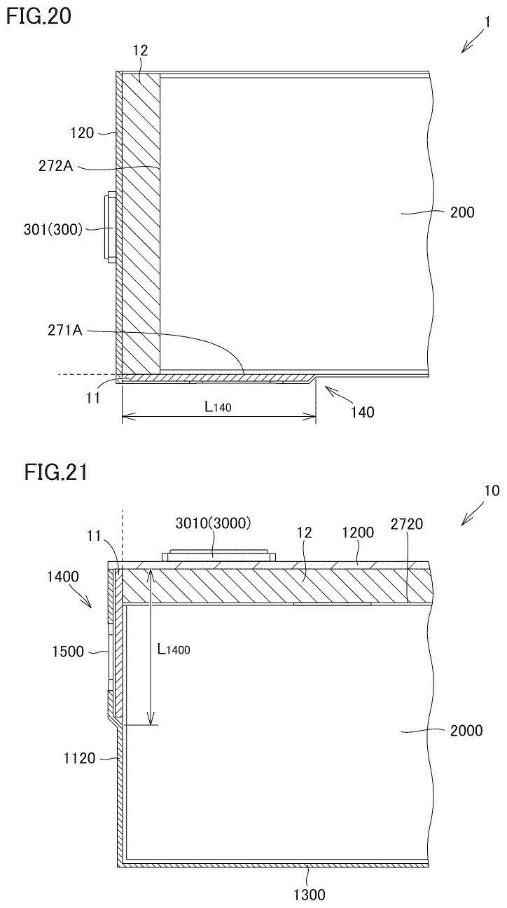

FIGS. 20 and 21 are diagrams for illustrating the spaces in the respective cases of secondary batteries 1, 10 according to the first and second embodiments. A broken line in each of FIGS. 20 and 21 is an imaginary straight line obtained by extending the inner surface of the base portion in the extending direction thereof.

In the example of FIG. 20 (first embodiment), a first space 11 is formed between protruding portion 140 and electrode assembly 200, and a second space 12 is formed between first sealing plate 120 (third wall) and electrode assembly 200.

In the example of FIG. 21 (second embodiment), a first space 11 is formed between protruding portion 1400 and electrode assembly 200, and a second space 12 is formed between sealing plate 1200 (third wall) and electrode assembly 200.

In the example of FIG. 20, the width of second space 12, i.e., a distance between short side surface 272A of electrode assembly 200 and first sealing plate 120 is preferably about 5 mm or more, and more preferably about 8 mm or more. Also in the example of FIG. 21, the width of second space 12, i.e., a distance between upper surface 2720 of electrode assembly 2000 and sealing plate 1200 is preferably about 5 mm or more, and more preferably about 8 mm or more.

In each of the examples of FIGS. 20 and 21, a length L₁₄₀, L₁₄₀₀ of protruding portion 140, 1400, is, for example, about 1/10 or more of the a total length of case 100, 1000 in the same direction.

In each of the examples of FIGS. 20 and 21, the volume of first space 11 is preferably about 120 mm³ or more (more preferably about 200 mm³ or more, still more preferably about 300 mm³ or more, and further preferably about 400 mm³ or more), and a ratio (volume percentage) of the volume of first space 11 to the internal volume of case 100, 100 is preferably about 0.05% or more. Further, the volume of second space 12 is preferably about 1100 mm³ or more, and a ratio (volume percentage) of the volume of second space 12 to the internal volume of case 100, 1000 is preferably about 1.5% or more.

It should be noted that each of the values of the internal volume of case 100, 100 and the volumes of first space 11 and second space 12 is calculated with a portion occupied by electrode assembly 200, 2000 or other component(s) being also included as the volume of the space.

According to first space 11 and second space 12 illustrated in each of FIGS. 20 and 21, first space 11 formed on the inner side with respect to protruding portion 140, 1400 and second space 12 adjacent to short side surface 272A or upper surface 2720 of electrode assembly 200 can securely communicate with each other, with the result that the discharge path for guiding, to gas-discharge valve 150, the gas jetted from electrode assembly 200 can be surely secured in the case.

### (Configuration of Battery Assembly)

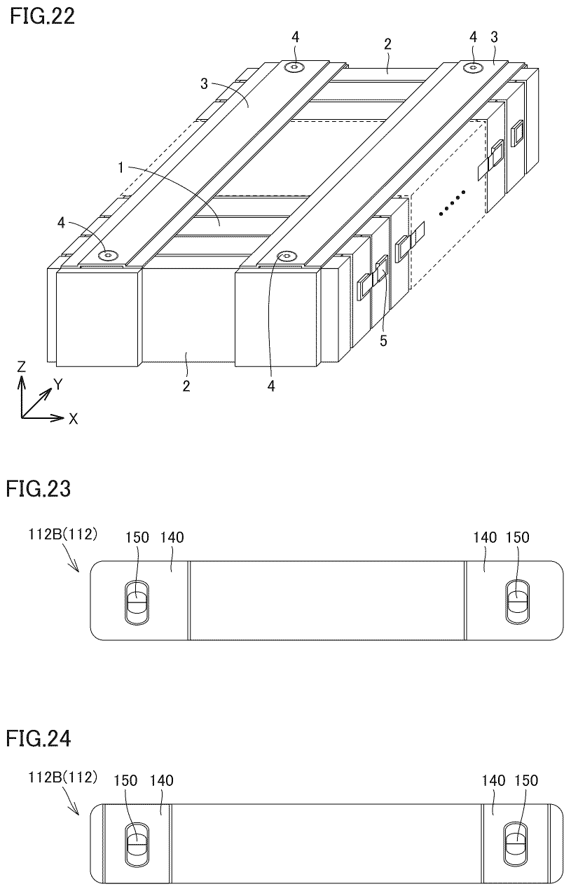

FIG. 22 is a perspective view showing a state in which secondary batteries 1 according to the first embodiment are stacked to form a battery assembly.

As shown in FIG. 22, when forming a battery assembly including secondary battery 1, a plurality of secondary batteries 1 are stacked in the thickness direction of each of the plurality of secondary batteries 1. End plates 2 are provided at both ends of stacked secondary batteries 1. A stack of secondary batteries 1 and end plates 2 is restrained in the stacking direction (Y direction) by restraint members 3, thereby forming the battery assembly. Both ends of each restraint member 3 are fixed to end plates 2 by fastening members 4. The plurality of secondary batteries 1 are electrically connected by bus bars 5. In FIG. 22, secondary batteries 1 are not shown in the central portion in the Y direction, but the number of secondary batteries 1 stacked can be appropriately changed.

A duct through which the gas or the like discharged from gas-discharge valve 150 flows in the Y direction may be provided at a position to avoid restraint member 3.

It should be noted that the configuration of the battery assembly is not limited to the one illustrated in FIG. 22, and the battery assembly may be directly supported on a side surface of a case of a battery pack without using end plates 2, restraint members 3, and fastening members 4, for example.

### (Arrangements of Protruding Portion 140 and Gas-Discharge Valve 150)

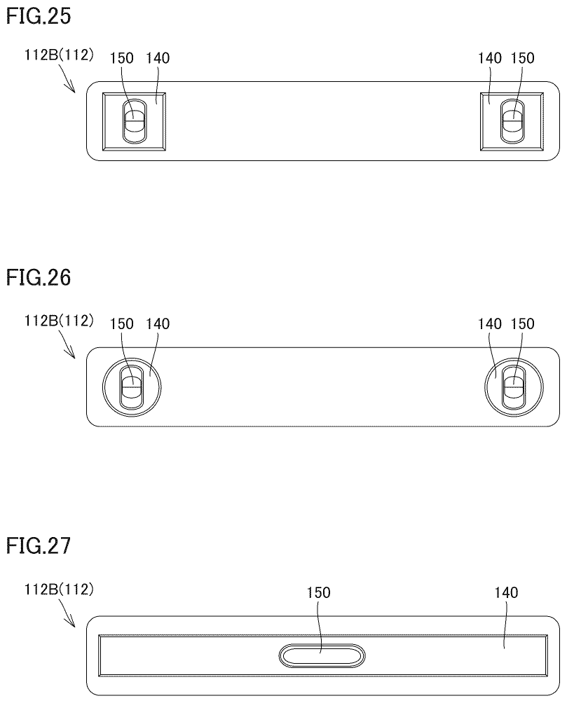

FIGS. 23 to 27 are diagrams each showing exemplary arrangements of protruding portion 140 and gas-discharge valve 150 in secondary battery 1 according to the first embodiment.

As in the example of each of FIGS. 23 to 26, a pair of protruding portions 140 and a pair of gas-discharge valves 150 may be provided laterally symmetrically in bottom surface portion 112B of case main body 110, whereas as in the example of FIG. 27, one protruding portion 140 extending in the long-side direction of bottom surface portion 112B may be provided and one gas-discharge valve 150 may be provided in the central portion thereof.

In each of the examples of FIGS. 23 to 27, first space 11 formed on the inner side with respect to protruding portion 140 and second space 12 formed beside each of the both sides of electrode assembly 200 communicate with each other, thereby surely securing the discharge path through which the gas or the like discharged from short side surface 272A of electrode assembly 200 reaches gas-discharge valve 150.

The arrangements of protruding portion(s) 140 and gas-discharge valve(s) 150 are not limited to those illustrated in FIGS. 23 to 27, and for example, a plurality of gas-discharge valves 150 may be disposed in one protruding portion 140. Further, the shape or size of each of protruding portion(s) 140 and gas-discharge valve(s) 150 can be appropriately changed.

### (Function and Effect)

According to secondary battery 1, 10 described above, by providing gas-discharge valve 150, 1500 in protruding portion 140, 1400 protruding in the direction away from electrode assembly 200, 2000, the discharge path through which high-temperature gas or the like generated in case 100, 1000 reaches the gas-discharge valve can be stably secured. Therefore, when the internal pressure of case 100, 1000 is increased to require discharging of the gas, gas-discharge valve 150, 1500 can stably function to suppress rapture at an unintended location. Thus, according to secondary battery 1, 10 described above, reliability of gas-discharge valve 150, 1500 can be improved.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A prismatic secondary battery comprising:
an electrode assembly including a positive electrode and a negative electrode; and
a case that accommodates the electrode assembly, wherein
the case includes a pair of first walls facing each other, a pair of second walls facing each other, and a pair of third walls facing each other,
the electrode assembly has a positive electrode tab on a surface of the electrode assembly facing one of the pair of third walls, the positive electrode tab being electrically connected to the positive electrode,
the electrode assembly has a negative electrode tab on a surface of the electrode assembly facing either of the pair of third walls, the negative electrode tab being electrically connected to the negative electrode,
a positive electrode terminal electrically connected to the positive electrode tab is provided on the third wall of the pair of third walls that faces the positive electrode tab,
a negative electrode terminal electrically connected to the negative electrode tab is provided on the third wall of the pair of third walls that faces the negative electrode tab,
at least one of the pair of second walls includes a base portion and a protruding portion protruding from the base portion in a direction away from a first end surface of the electrode assembly, and
the protruding portion is provided with a gas-discharge valve that is fractured when pressure in the case becomes equal to or more than a predetermined value.

2. The prismatic secondary battery according to claim 1, wherein at least one of the pair of third walls is connected to a portion of the second wall at which the protruding portion is provided.

3. The prismatic secondary battery according to claim 2, wherein
the electrode assembly has a second end surface on which at least one of the positive electrode tab and the negative electrode tab is provided,
a first space is formed between the protruding portion and the first end surface of the electrode assembly,
a second space is formed between the third wall and the second end surface of the electrode assembly, and
the first space and the second space communicate with each other.

4. The prismatic secondary battery according to claim 1, further comprising an insulating sheet disposed between the protruding portion and the first end surface of the electrode assembly, wherein
the insulating sheet is disposed at a position close to the first end surface of the electrode assembly with respect to an inner surface of the protruding portion.

5. The prismatic secondary battery according to claim 1, wherein
at least one of the pair of third walls is connected to a portion of the second wall at which the protruding portion is provided,
the prismatic secondary battery further comprising an insulating sheet disposed between the protruding portion and the first end surface of the electrode assembly, wherein
the insulating sheet is disposed at a position close to the first end surface of the electrode assembly with respect to an inner surface of the protruding portion.

6. The prismatic secondary battery according to claim 1, wherein
at least one of the pair of third walls is connected to a portion of the second wall at which the protruding portion is provided,
the electrode assembly has a second end surface on which at least one of the positive electrode tab and the negative electrode tab is provided,
a first space is formed between the protruding portion and the first end surface of the electrode assembly,
a second space is formed between the third wall and the second end surface of the electrode assembly, and
the first space and the second space communicate with each other,
the prismatic secondary battery further comprising an insulating sheet disposed between the protruding portion and the first end surface of the electrode assembly, wherein
the insulating sheet is disposed at a position close to the first end surface of the electrode assembly with respect to an inner surface of the protruding portion.

7. The prismatic secondary battery according to claim 1, wherein
the protruding portion includes a first protruding portion included in one of the pair of second walls and a second protruding portion included in the other of the pair of second walls, and
the gas-discharge valve includes a first gas-discharge valve provided in the first protruding portion and a second gas-discharge valve provided in the second protruding portion.

8. The prismatic secondary battery according to claim 1, wherein
at least one of the pair of third walls is connected to a portion of the second wall at which the protruding portion is provided,
the electrode assembly has a second end surface on which at least one of the positive electrode tab and the negative electrode tab is provided,
a first space is formed between the protruding portion and the first end surface of the electrode assembly,
a second space is formed between the third wall and the second end surface of the electrode assembly, and
the first space and the second space communicate with each other,
the prismatic secondary battery further comprising an insulating sheet disposed between the protruding portion and the first end surface of the electrode assembly, wherein
the insulating sheet is disposed at a position close to the first end surface of the electrode assembly with respect to an inner surface of the protruding portion,
the protruding portion includes a first protruding portion included in one of the pair of second walls and a second protruding portion included in the other of the pair of second walls, and
the gas-discharge valve includes a first gas-discharge valve provided in the first protruding portion and a second gas-discharge valve provided in the second protruding portion.
